(19) United States
(12) Patent Application Publication
(10) Pub. No.: US 2005/0112422 A1
(43) Pub. Date: May 26, 2005

(54) Fuel cell and fuel cell separator

(75) Inventors: Yasunori Yoshimoto, Ashikaga-City (JP); Hirokazu Izaki, Ashikaga-City (JP); Akira Hamada, Ashikaga-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/975,054

(22) Filed: Oct. 28, 2004

(30) Foreign Application Priority Data
Oct. 29, 2003 (JP) 2003-369507

(51) Int. Cl. H01M 8/18; H01M 8/04; H01M 8/12; H01M 2/00; H01M 2/02; H01M 2/14

(52) U.S. Cl. 429/19; 429/20; 429/34; 429/38; 429/39

(57) ABSTRACT

A pair of separators sandwiches an electrode assembly of fuel cell including an electrolyte and a pair of electrodes provides on respective sides of the electrolyte. The separator facing a fuel electrode is provided with a coolant introduction passage on the back of a fuel introduction passage and a second manifold for fuel supply.

### BACKGROUND OF THE INVENTION

1. Field of the Invention

The present invention relates to a fuel cell and a separator for a fuel cell.

2. Description of the Related Art

Recently, fuel cells are a focus of attention due to its high energy conversion efficiency and absence of hazardous substance in an outcome of electricity generation. A polymer electrolyte fuel cell, operating in a temperature of 100° C. or lower, is known as one type of fuel cell.

A polymer electrolyte fuel cell is an apparatus having a basic structure in which a solid polymer electrolyte membrane is provided between a fuel electrode and an air electrode. A fuel gas containing hydrogen is supplied to the fuel electrode and an oxidizing gas containing oxygen is supplied to the air electrode so that power is generated as a result of a reaction formulated as follows.
Fuel electrode: H₂—>2H⁺+2e⁻ (1)
Air electrode: ½O₂+2H⁺+2e⁻—>H₂O (2)
At the fuel electrode, hydrogen contained in the supplied fuel is dissolved into hydrogen ions and electrons as indicated by formula (1) above. Hydrogen ions travel inside a solid polymer electrolyte membrane toward the air electrode. Electrons travel to the air electrode via an external circuit. At the air electrode, oxygen contained in the oxidizing gas supplied to the air electrode react with hydrogen ions and electrons arriving from the fuel electrode so that water is generated as indicated by formula (2) above. Thus, electric power is extracted since electrons travel in the external circuit from the fuel electrode to the air electrode.

Separators are provided outside the fuel electrode and the air electrode. The separator outside the fuel electrode is provided with a fuel gas passage so that the fuel gas is supplied to the fuel electrode. Similarly, the separator outside the air electrode is provided with an oxidizing gas passage so that the oxidizing gas is supplied to the air electrode. The fuel gas and the oxidizing gas are generically referred to as reactant gases in this specification. A passage for cooling water, a coolant for cooling the electrodes, is provided between the separators.

The reactant gases are usually introduced after being moistened by a humidifier. A manifold for supplying a reactant gas is usually provided in a member surrounding a separator and the temperature of the manifold for supplying the reactant gas drops as a result of heat dissipation. The temperature of the reactant gas with a high dew-point temperature drops as it is introduced into a manifold so that a large quantity of condensed water is generated. No provision is provided in the related-art fuel cell separator to prevent the cooling of the reactant gas as it is introduced from a reactant gas supplying hole to a reactant gas passage. Therefore, there is a problem in that condensed water derived from the reactant gas is collected on the reactant gas supplying hole of the separator, or condensed water from the reactant gas supplying hole invades the reactant gas passage. Thus, in the related-art fuel cell separator, the passage for the reactant gas may be blocked by condensed water, and uniform supply of the reactant gas to the surface of electrode is prohibited, with a result that an output of the fuel cell drops.

Accordingly, there is proposed a technology for avoiding a drop in the battery performance due to condensation of water in the gas or dew formation. The patent document No. 1 describes heat-up of a gas inlet manifold, by providing a conduit for water cooling the separator in the vicinity of the side wall of the opening used for supplying the fuel gas.

The structure of the patent document No. 1, however, has room for improvement in respect of prevention of a drop in the fuel cell output. Moreover, the structure requires a provision of a communicating conduit for supplying heated water to the gas inlet of, so that the overall structure of the fuel cell becomes complex and excessively large.

Related Art List

Patent document No. 1: Japanese Laid-Open Patent Application No. 10-64562

### SUMMARY OF THE INVENTION

The present invention has been done in view of the above-described circumstances and an objective thereof is to provide a technology for stabilizing the output characteristics of a fuel cell.

The inventors have made a study focused on the stabilization of the output characteristics of a fuel cell. It was found as a result of the study that the related-art structure of a fuel cell cannot properly prevent the supply of a reactant gas from being blocked by condensed water generated from a moistened reactant gas.

In the structure disclosed in the patent document No. 1, a gas inlet formed on one surface of a separator is a through hole opening into the other surface where a gas inlet manifold is formed. Although a cooling water channel is provided in the vicinity of the gas inlet, the structure fails to prevent the cooling of the reactant gas in a supply path that guides the reactant gas from the gas inlet to the gas channel via the gas inlet manifold. Therefore, stable supply of the reactant gas is prohibited by condensed water generated in the gas inlet manifold or the gas channel.

When the moistened reactant gas with a high dew point temperature is cooled by heat dissipation, condensed water is generated. When condensed water is generated, the supply path for the reactant gas is blocked by water so that the reactant gas is prevented from flowing smoothly. This results in unstable output characteristics. Accordingly, the inventors have made a study from a view point of preventing the cooling of the reactant gas in the upstream of the supply path for the reactant gas and increasing the temperature of the reactant gas before arriving at the present invention.

The present invention provides a fuel cell comprising: a membrane and electrode assembly having an electrolyte and a pair of electrodes provided on respective sides of the electrolyte; and a pair of separators sandwiching the membrane and electrolyte assembly, wherein each of the pair of separators is provided with an opening for supply of a reactant gas, one of surfaces of each separator is provided with reactant gas passages and a reactant gas introduction passage for guiding the reactant gas from the opening to the reactant gas passages, and a coolant passage is provided on the back of the reactant gas introduction passage of at least one of the pair of separators.

In the fuel cell according to the present invention, a coolant, which is originally intended as a means for removing heat of reaction, is supplied on the back of a reactant gas introduction passage. Accordingly, the cooling of the reactant gas is prevented by the heat of the coolant and the temperature of the reactant gas is increased. As a result, condensed water is prevented from being generated in the vicinity of the reaction gas introduction passage and a manifold. It is thus ensured that a reactant gas at a high humidity is supplied to the membrane and electrode assembly. Condensed water is prevented from advancing into the reactant gas introduction passage so that the reactant gas is supplied in a stable manner. Accordingly, it is possible to provide a fuel cell with excellent output stability.

The present invention also provides a fuel cell separator comprising: an opening for supply of a reactant gas; reactant gas passages provided on one of separator surfaces; and a reactant gas introduction passage for guiding the reactant gas from the opening to the reactant gas passages, wherein a coolant passage is provided on the back of the reactant gas introduction passage.

In the fuel cell separator according to the present invention, a coolant passage is provided on the back of the reactant gas introduction passage. Accordingly, the reactant gas introduction passage is properly heated from the back thereof. This prevents the generation of condensed water due to the cooling of the reactant gas guided from the opening for supply of the reactant gas to the reactant gas introduction passage. Therefore, the reactant gas is supplied to the reactant gas passages via the reactant gas introduction passage in a stable manner. It is thus ensured that the output of the fuel cell is stabilized.

The reactant gas introduction passage may guide the reactant gas from the lateral of the opening for supply of the reactant gas to the reactant gas passage.

The coolant passage may be formed so that the coolant flows around the entirety of the opening for supply of the reactant gas.

In the fuel cell according to the present invention, an opening for supply of the coolant may be provided in the pair separators, the opening for supply of the reactant gas and the opening for supply of the coolant may be provided above the reactant gas passages, the opening for supply of the coolant may be located substantially above the opening for supply of the reactant gas, and the coolant may flow vertically downward from the opening for supply of the coolant.

In the fuel cell according to the present invention, the reactant gas introduction passage may include a connecting passage that runs upward from the opening for supply of the reactant gas.

In the fuel cell according to the present invention, the opening for supply of the coolant may be located between two openings for supply of the reactant gas respectively supplying a fuel gas and an oxidizing gas, and the opening for supply of the coolant may be closer to the opening supplying the fuel gas than to the opening supplying the oxidizing gas.

In the fuel cell according to the present invention, it is preferable that the coolant is higher in temperature than the fuel gas or the oxidizing gas.

The present invention also provides a fuel cell separator constructed such that a first base plate and a second base plate are in contact with each other, wherein the first base plate comprises: an opening for supply of a reactant gas; reactant gas passages provided on a surface of the first base plate which is not in contact with the second base plate; and a reactant gas introduction passage for guiding the reactant gas from the opening for supply of the reactant gas to the reactant gas passages, and wherein the second base plate is provided with a cooling water passage on a surface of the second base plate which is in contact with the first base plate.

### BRIEF DESCRIPTION OF THE DRAWINGS

FIGS. 1A and 1B show a structure of a fuel cell separator according to a first embodiment of the present invention.

FIGS. 2A and 2B show a structure of another fuel cell separator according to the first embodiment.

FIGS. 3A and 3B are exploded perspective view of a fuel cell stack that includes fuel cell separators of FIGS. 1A, 1B, 2A and 2B.

FIG. 4 is a perspective view showing a structure of a fuel cell that includes a fuel cell stack of FIGS. 3A and 3B.

FIG. 5 is a schematic, enlarged view showing a structure of a part of the fuel cell separator of FIGS. 1A, 1B, 2A and 2B.

FIG. 6 shows a structure of a surface of a fuel cell separator according to a second embodiment on which surface coolant passages are provided.

FIG. 7 is a schematic, enlarged view showing a structure of a part of the fuel cell separator of FIG. 6.

FIG. 8 is a schematic view showing a section of the cell according to the embodiments.

FIG. 9 shows a structure of a fuel cell separator according to a variation of the first embodiment.

FIGS. 10A and 10B show a method of fabricating a fuel cell separator according to the embodiments.

### DETAILED DESCRIPTION OF THE INVENTION

A description will now be given of the embodiments of the present invention by referring to the attached drawings. In the drawings, like components are denoted by like reference symbols and descriptions already given are omitted.

### First Embodiment

In the first embodiment, a fuel cell separator in which fuel passages are formed on a surface thereof so as to be substantially parallel with each other, and a fuel cell separator in which air passages are formed on a surface thereof so as to be substantially parallel with each other will be described. A fuel cell provided with these separators will be described. In the first embodiment, a structure in which coolant passages for a coolant such as a cooling water are formed on the back of the fuel passages will be described. Alternatively, the coolant passages may be formed on the back of the air passages. A fuel cell separator in which the coolant passages are formed on a surface thereof may be provided aside from the fuel electrode separator and the air electrode separator.

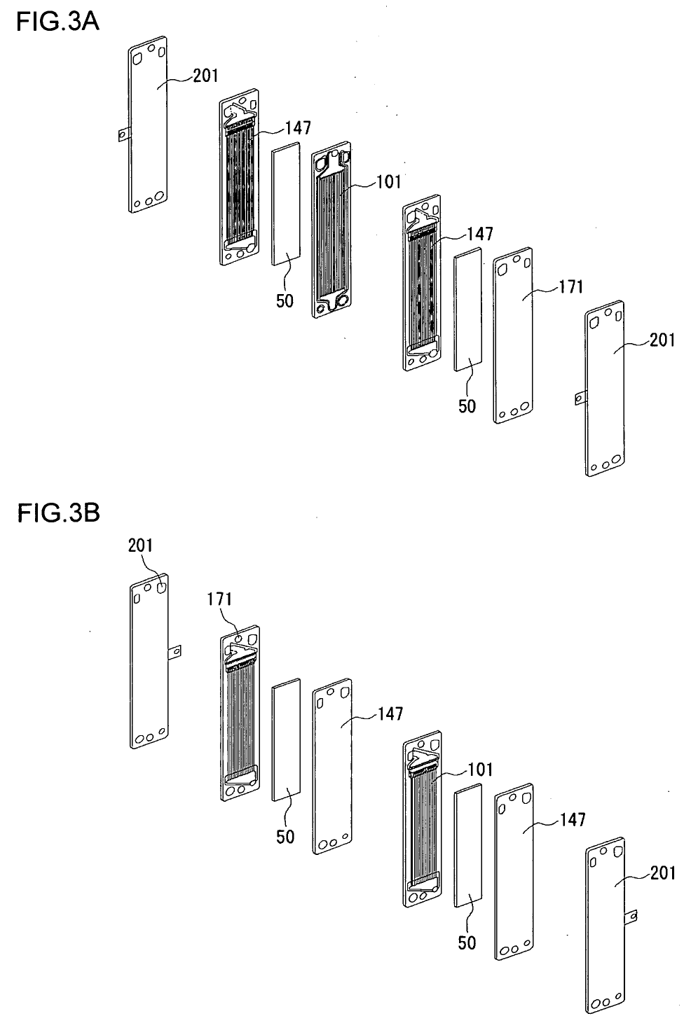

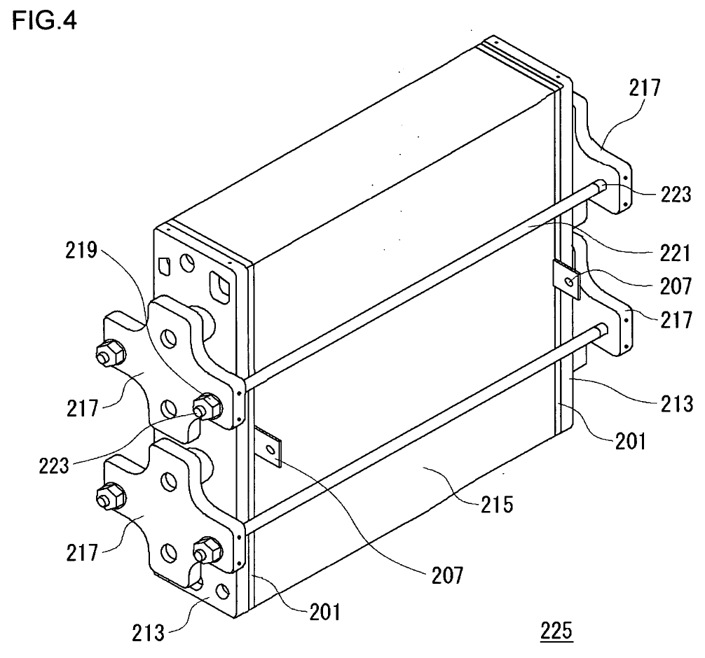

FIG. 3A is an exploded perspective view of a structure of a fuel cell stack that includes fuel cell separators according to the first embodiment. FIG. 3B is an exploded perspective view of a back side of the fuel cell stack of FIG. 3A. FIG. 4 is a perspective view of a structure of a fuel cell that includes the fuel cell stack of FIG. 3A and FIG. 3B.

In FIGS. 3A and 3B, a two-cell structure is shown as an example of stack structure. A fuel electrode separator 101 is provided adjacent to the side of a cell 50 facing the fuel electrode. An air electrode separator 147 is provided adjacent to the side of the cell 50 facing the air electrode. A stack is obtained by laminated a desired number of laminated units each comprising the separator 101, the cell 50 and the separator 147. In the fuel cell according to the first embodiment, no limit is imposed on the number of cells 50 in the stack. For example, a stack of 50-200 cells may be produced. An insulator 201 and an end plate 213 (not shown in FIGS. 3A and 3B) are provided in the stated order toward the exterior of the fuel cell. The fuel electrode separator adjacent to the insulator 201 is a fuel electrode separator 171 in which coolant passages are not provided. The fuel electrode separator 101 may be used in place of the fuel electrode separator 171. The fuel cell separators are provided to form a stack such that the length of a base plate thereof is vertical.

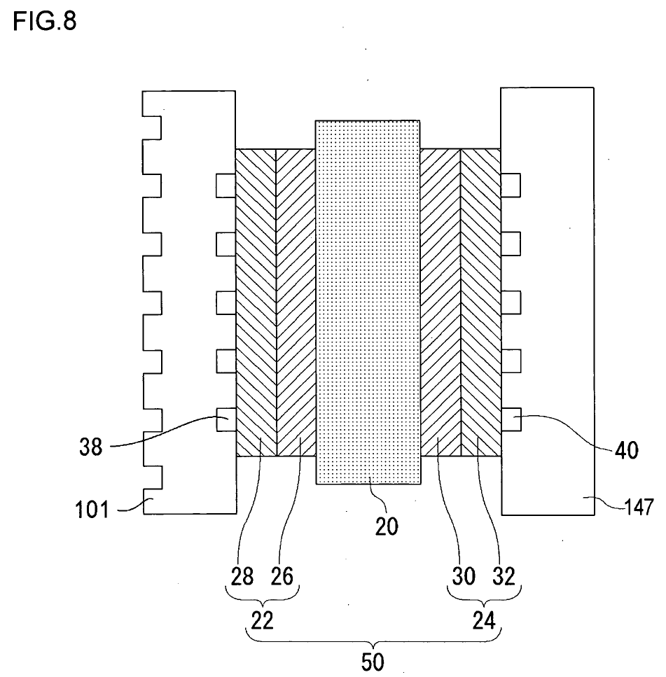

A description will now be given of a structure of the cell 50. FIG. 8 is a schematic section of the cell 50 sandwiched by the separators. The fuel electrode separator 101 and the air electrode separator 147 are provided at the respective sides of the cell 50. In this example, only one cell 50 is shown. Alternatively, the fuel cell may be constructed by laminating of a plurality of cells 50 each interposed between the fuel electrode separator 101 and the air electrode separator 147, the fuel electrode separator 101 being contiguous with the fuel electrode separator 101 and the air electrode separator 147 being contiguous with the air electrode separator 147.

The cell 50 is provided with a solid polymer electrolyte membrane 20, a fuel electrode 22 and an air electrode 24. The fuel electrode 22 has a laminate of a catalytic layer 26 and a gas diffusion layer 28, and the air electrode 24 similarly has a laminate of a catalytic layer 30 and a gas diffusion layer 32. The catalytic layer 26 of the fuel electrode 22 and the catalytic layer 30 of the air electrode 24 are provided opposite to each other, sandwiching the solid polymer electrolyte membrane 20.

Gas passages 38 are provided in the fuel electrode separator 101 provided adjacent to the fuel electrode 22. A fuel gas is supplied to the cell 50 via the gas passages 38. Similarly, gas passages 40 are provided in the air electrode separator 147 provided adjacent to the air electrode 24. An oxidization gas is supplied to the cell 50 via the gas passages 40. More specifically, when the fuel cell is operated, a fuel gas such as hydrogen gas is supplied to the fuel electrode 22 via the gas passages 38 and an oxidizing gas such as air is supplied to the air electrode 24 via the gas passages 40.

The solid polymer electrolyte membrane 20 preferably displays good ionic conductivity in a humid condition and functions as an ion exchange membrane causing the protons to move between the fuel electrode 22 and the air electrode 24. For example, the solid polymer electrolyte membrane 20 is formed of a solid polymer material such as fluorinated polymer or non-fluorinated polymer. For example, perfluorocarbon polymer of a sulfonic acid type, polysulphone resin, or perfluorocarbon polymer having a phosphonic acid group or carboxylic acid group may be used. Nafion (TM) 112 from DuPont is an example of perfluorocarbon polymer of a sulfonic acid type. Aromatic sulfonated polyetheretherketone and polysulfone are examples of non-fluorinated polymer.

The catalytic layer 26 in the fuel electrode 22 and the catalytic layer 30 in the air electrode 24 are porous membranes and are preferably formed of an ion exchange resin and carbon particles carrying a catalyst. The catalyst carried may be a mixture comprising at leastone of platinum, ruthenium and rhodium. The carbon particles carrying the catalyst may be acetylene black, Ketjen Black, etc.

The ion exchange resin connects the carbon particles carrying the catalyst and the solid polymer electrolyte membrane 20 so as to conduct protons between the particles and the membrane. The ion exchange resin may be formed of a polymer material similar to the one that forms the solid polymer electrolyte membrane 20.

The gas diffusion layer 28 in the fuel electrode 22 and the gas diffusion layer 32 in the air electrode 24 have the function of supplying hydrogen gas and air to the catalyst layer 26 and the catalyst layer 30, respectively. The diffusion layers also have the function of moving electric charges generated by the power generation reaction to an external circuit and of discharging water and non-reacting gas outside. The gas diffusion layer 28 and the gas diffusion layer 32 are preferably formed of a porous material having electron conductivity. For example, the layers may be formed of carbon paper or carbon cloth.

Referring to FIG. 4, a fuel cell 225 according to the first embodiment is constructed such that a pair of current collector plates 207, the insulators 201, the end plates 213 are provided around a cell stack 215 in the stated order toward the exterior of the fuel cell. Tie plates 217 are provided at the outermost edges. By providing the current collector plate 207, electricity generated by the cell stack 215 is collected outside the fuel cell. By providing the end plate 213, a uniform compression weight can be applied to the surfaces of the plates constituting the cell stack 215.

Two tie plates 217 sandwiching the cell stack 215 are provided at each of the edges. Tie rods 221 provided with screw threads 223 at both ends thereof are guided through the tie plates 217 so that the tie plates 217 are clamped by nuts 219. With this, the cell stack 215, the current collector plates 207, the insulators 201 and the end plates 213 are integrated in a state that the compression weight is applied. The insulators 201 may be formed of substance having insulating properties and heat resistance at an operating temperature of the fuel cell. For example, the insulator 201 may be formed of polyphenylene sulfide (PPS). A heat insulator (not shown) may be provided around the fuel cell 225.

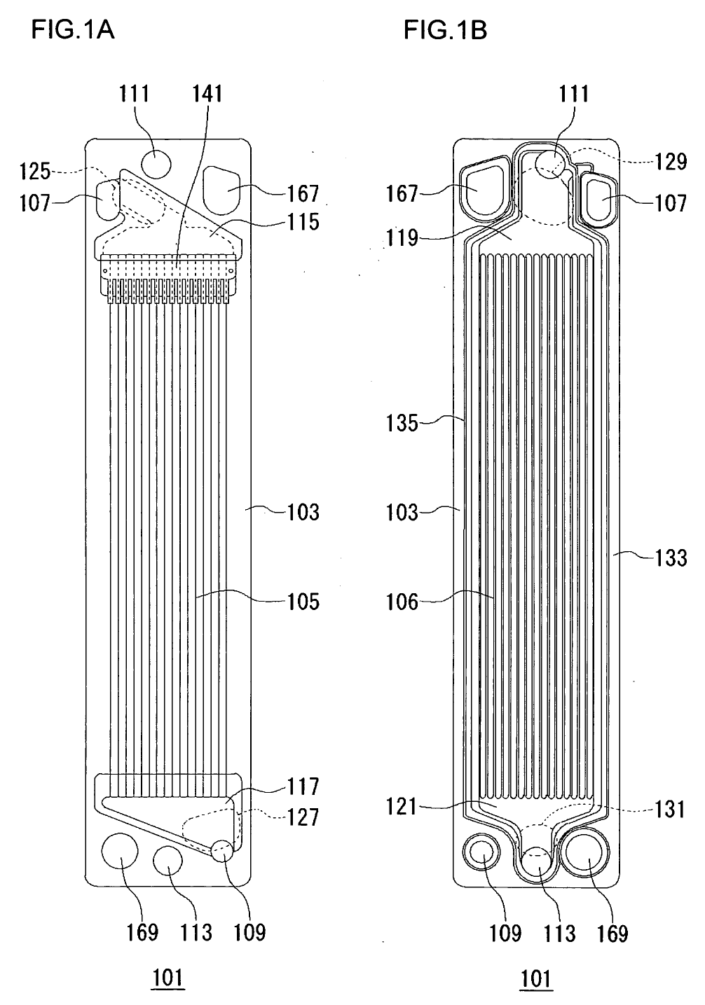

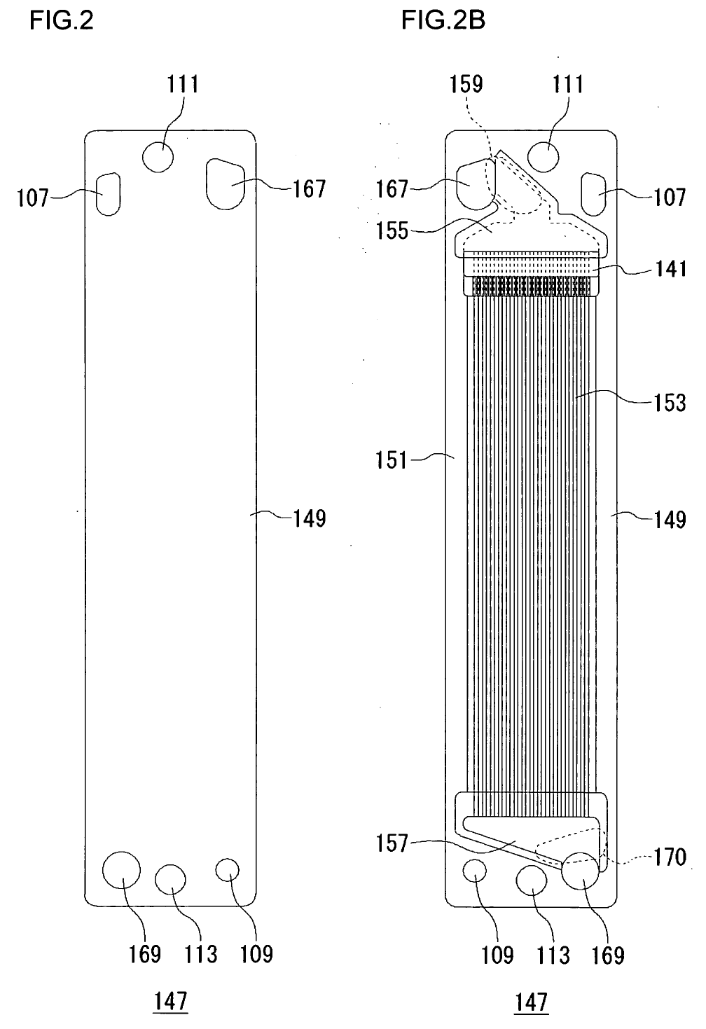

A description will now be given of a structure of the fuel electrode separator 101 and the air electrode 147 by referring to FIGS. 1A, 1B, 2A and 2B.

FIG. 1A is an elevation of the surface of the fuel cell separator according to the first embodiment in which fuel passages are provided at one of the surfaces. FIG. 1B is an elevation of the other surface of the fuel cell separator of FIG. 1A in which coolant passage 106 are provided.

In the first embodiment, one of the surfaces of a base plate 103 of the fuel electrode separator 101 is provided with fuel passages 105 as shown in FIG. 1A and the other surface thereof is provided with coolant passages 106 as shown in FIG. 1B. The fuel passages 105 correspond to the gas passages 38 of FIG. 8.

As shown in FIGS. 1A and 1B, the base plate 103 is provided with a first manifold for fuel supply 107, a first manifold for air supply 167 and a first manifold for coolant supply 111, forming passages for supply of fuel gas, air and coolant, respectively, in the direction of lamination of the fuel cell stack. The base plate 103 is also provided with a first manifold for fuel gas emission 109, a first manifold for air emission 169, a first manifold for coolant emission 113, forming passages for emission of fuel gas, air and coolant, respectively, in the direction of lamination of the fuel cell stack.

In the first embodiment, the coolant is used for removal of heat of reaction occurring in the electrodes of the fuel cell. Preferably, the coolant is at a temperature higher than that of at least one of the fuel gas and air. With this, the cooling of the fuel gas or air is properly controlled. For example, the temperature of the fuel gas or air may be 65-70° C. and the temperature of coolant in the first manifold for coolant supply 111 may be 71° C.

A detailed description will now be given of the respective surfaces of the base plate 103.

As shown in FIG. 1A, one of the surfaces of the base plate 103 is provided with a fuel introduction passage 125 for introducing a fuel gas from the first manifold for fuel supply 107, a plurality of fuel passages 105 formed substantially parallel with each other along the length of a rectangular area for formation of the passages, a second manifold for fuel supply 115 connecting the fuel introduction passage 125 with the plurality of fuel passages 105, a fuel emission passage 127 for emission of a fuel gas via the first manifold for fuel emission 109, and a second manifold for fuel emission 117 connecting the plurality of fuel passages 105 with the fuel emission passage 127.

The first manifold for coolant supply 111 is provided at a position substantially higher than that of the first manifold for fuel supply 107 and the first manifold for air supply 167. In other words, the bottom of the first manifold for coolant supply 111 is provided above the bottom of the first manifold for fuel supply 107 and the first manifold for air supply 167.

A nozzle 141 is provided between the second manifold for fuel supply 115 and the fuel passages 105. By providing the nozzle 141, resistance is created at the entrance of the fuel passages 105. By forming a step such that the second manifold for fuel supply 115 and the nozzle 141 have the identical passage depth, or the second manifold for fuel supply 115 and the fuel introduction passage 125 have the identical passage depth, the fuel gas is supplied efficiently. The material forming the nozzle 141 may be a resin. It is preferable that the material exhibit an excellent fluidity while being molded, be accurate in dimension in a finished state, be slightly flexible and be excellent in heat conduction capability. For example, the nozzle 141 may be integrally formed using polyacetal, polymethylpentene, polyphenylene ether, polyphenylene sulfide or liquid crystal polymer.

The diameter of the opening of the nozzle 141 is determined such that a pressure drop is generated in the upstream of the fuel passages 105 so that condensed water is removed. For example, the diameter of the opening of the nozzle 141 at the entrance thereof adjacent to the second manifold for fuel supply 115 may be 0.25 mm. Since the nozzle 141 is configured such that a pressure drop in the fuel passages 105 is uniform from passage to passage and the quantity of fuel gas passing the fuel passages 105 is uniform from passage to passage. The nozzle 141 is also configured such that water content control in the fuel passages 105 is effected properly, and dry-up of the solid polymer electrolyte membrane and blocking of the fuel passages 105 by water drops generated by condensation are prevented. Accordingly, an electrochemical reaction at the electrode is stabilized and be made uniform. Since a proper electrochemical reaction is performed over the entirety of the area, the output of the fuel cell is stabilized.

In the fuel cell separator constructed as described above, the fuel gas is supplied from the first manifold for fuel supply 107 to the second fuel supply manifold 115 via the fuel introduction passage 125 formed lateral to the first manifold for fuel supply 107, and then supplied from the second manifold for fuel supply 115 to the fuel passages 105 via the nozzle 141. The fuel gas past the fuel passages 105 arrives at the first manifold for fuel emission 109 from the second manifold for fuel emission 117 via the fuel emission passage 127. The fuel gas is emitted in the direction of lamination of the fuel cell stack so as to be exhausted outside the base plate 103.

As shown in FIG. 1B, the other surface of the base plate 103 is provided with a coolant introduction passage 129 for introducing coolant from the first manifold for coolant supply 111, a plurality of coolant passages 106 formed substantially parallel with each other along the length of a rectangular area for formation of the passages, a second manifold for coolant supply 119 connecting the coolant introduction passage 129 with the plurality of coolant passages 106, a coolant emission passage 131 for emission of coolant via the first manifold for coolant emission 113, and a second manifold for coolant emission 121 connecting the plurality of coolant passages 106 with the coolant emission passage 131.

A sealing member 133 is pasted onto the surface of the base plate 103 around the coolant passages 106 so that a convex bead 135 is formed. This ensures proper adherence between the fuel electrode separator 101 with the other separator laminated in a stack and properly prevent leakage of gas and water. The sealing member 133 may be formed of an elastic material such as ethylene-propylene-diene-rubber (EPDM).

In the fuel cell separator constructed as described above, the coolant is supplied from the first manifold for coolant supply 111 to the second manifold for coolant supply 119 via the coolant introduction passage 129, and then supplied from the second manifold for coolant supply 119 to the coolant passages 106. The coolant past the coolant passages 106 arrives at the first manifold for coolant emission 113 from the second manifold for coolant emission 121 via the coolant emission passage 131. The coolant is emitted in the direction of lamination of the fuel cell stack so as to be exhausted outside the base plate 103.

FIGS. 2A and 2B illustrate a fuel cell separator according to the first embodiment in which air passages are formed on one surface thereof. As shown in FIGS. 2A and 2B, like the base plate 103 of FIGS. 1A and 1B, the base plate 149 is provided with a first manifold for fuel supply 107, a first manifold for air supply 167 and a first manifold for coolant supply 111, forming passages for supply of fuel gas, air and coolant, respectively, in the direction of lamination of the fuel cell stack. The base plate 149 is also provided with a first manifold for fuel gas emission 109, a first manifold for air emission 169, a first manifold for coolant emission 113, forming passages for emission of fuel gas, air and coolant, respectively, in the direction of lamination of the fuel cell stack.

In the first embodiment, one of the surfaces of a base plate 149 of a fuel cell separator is a flat surface in which passages as shown in FIG. 2A are not provided. The other surface is provided with air passages 153 as shown in FIG. 2B. The air passages 153 correspond to the gas passages 40 of FIG. 8.

FIG. 2B is an elevation of the other surface of the fuel cell separator of FIG. 2A. As shown in FIG. 2B, the other surface of the base plate 149 is provided with an air introduction passage 159 for introducing air from the first manifold for air supply 167, a plurality of air passages 153 formed substantially parallel with each other along the length of a rectangular area for formation of the passages, a second manifold for air supply 155 connecting the air introduction passage 159 with the plurality of fuel passages 153, an air emission passage 170 for emission of air via the first manifold for air emission 169, and a second manifold for air emission 157 connecting the plurality of air passages 153 with the air emission passage 170.

As in the separator 101, the area on the base plate 149 around the air passages 153 of the air electrode separator 147 is coated with the sealing member 151. A bead (not shown) ensures proper adherence of the air electrode separator 147 in a laminate.

The nozzle 141 is provided between the second manifold for air supply 155 and the air passages 153. A pressure sufficient for emission of condensed water in the air passages 153 is ensured so that the air is supplied to the air passages 153 uniformly.

In a similar configuration as the side of the fuel cell separator of FIG. 1A on which the fuel passages are provided, by forming a step such that the second manifold for air supply 155 and the nozzle 141 have the identical passage depth, or the second manifold air supply 155 and the air introduction passage 159 have the identical passage depth, air is supplied efficiently.

In the fuel cell separator constructed as described above, air is supplied from the first manifold for air supply 167 to the second air supply manifold 155 via the fuel introduction passage 159 formed lateral to the first manifold for air supply 167, and then supplied from the second manifold for air supply 155 to the air passages 153 via the nozzle 141. Air past the air passages 153 arrives at the first manifold for air emission 169 from the second manifold for air emission 157 via the air emission passage 170. Air is emitted in the direction of lamination of the fuel cell stack so as to be exhausted outside the base plate 149.

As shown in FIGS. 1A, 1B, 2A and 2B, the fuel introduction passage 125 and the air introduction passage 159 of the first embodiment are provided at a position substantially higher than that of the first manifold for fuel supply 107, which substantially has a configuration of an upright ellipse, and the first manifold for air supply 167, respectively. With this, the condensed water derived from the moistened fuel gas or air introduced via the first manifold for fuel supply 107 or the first manifold for air supply 167, respectively, remains at the bottom of the first manifold for fuel supply 107 or the first manifold for air supply 167, respectively, and is prevented from advancing into the fuel introduction passage 125 or the air introduction passage 159, respectively. Therefore, mixing of condensed water into the reactant gas or air occurring when the fuel gas moves from the lateral of the first manifold for fuel supply 107 to the second manifold for fuel supply 115 or when air moves from the lateral of the first manifold for air supply 167 to the second manifold for air supply 165, respectively, is prevented.

In the first embodiment, the first manifold for coolant supply 111 is substantially aligned with the first manifold for fuel supply 107 and the first manifold for air supply 167 in the direction of horizon of the base plate, and is provided at a position substantially higher than the first manifold for fuel supply 107 and the first manifold for air supply 167. The coolant introduction passage 129 is provided lower than the first manifold for coolant supply 111 so that the coolant flows from the first manifold for coolant supply 111 downward in the vertical direction, pulled by gravity. The coolant introduction passage 129 is formed so as to cut across the fuel introduction passage 125 or the air introduction passage 159.

With this, the coolant, which is originally intended as coolant for removing heat of reaction at the electrodes, cuts across the back side of where the fuel introduction passage 125 or the air introduction passage 159 is formed, as the coolant flows downward from the first manifold for coolant supply 111 toward the second manifold for coolant supply 119 via the coolant introduction passage 129. The heat of the coolant prevents the cooling of the fuel gas or air. It is therefore possible to prevent generation of condensed water derived from the moistened fuel gas or air around the fuel introduction passage 125 or the air introduction passage 159. Consequently, condensed water is prevented from advancing into the fuel introduction passage 125 or the air introduction passage 159 so that the fuel gas or air can be properly supplied. Thus, it is possible to provide a fuel cell with excellent output stability.

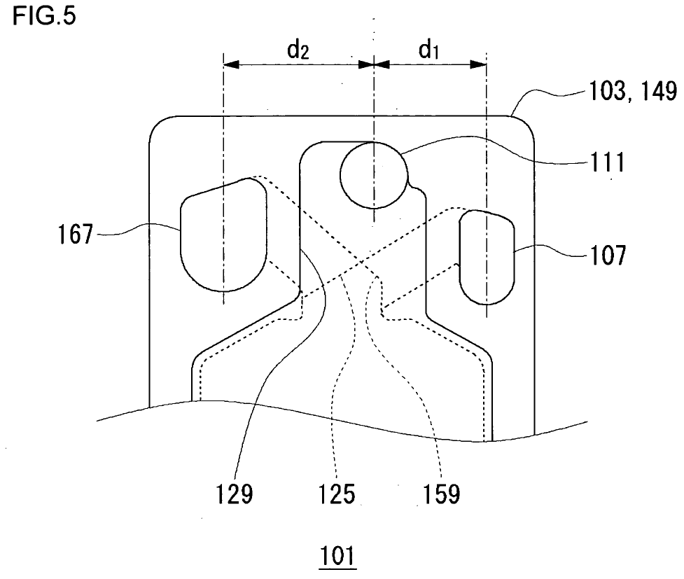

As shown in FIG. 5, the first manifold for coolant supply 111 is located between the first manifold for fuel supply 107 and the first manifold for air supply 167. The distance d1 between the first manifold for coolant supply 111 and the first manifold for fuel supply 107 is shorter than the distance d2 between the first manifold for coolant supply 111 and the first manifold for air supply 167.

The quantity of fuel gas being supplied is smaller than that of oxidizing gas. Therefore, given that the gas temperature is the same, the fuel gas is more easily affected by heat dissipation so that the temperature thereof easily drops. According to the structure as described above, the cooling of the fuel gas is effectively controlled so that generation of condensed water at the fuel gas supply is prevented.

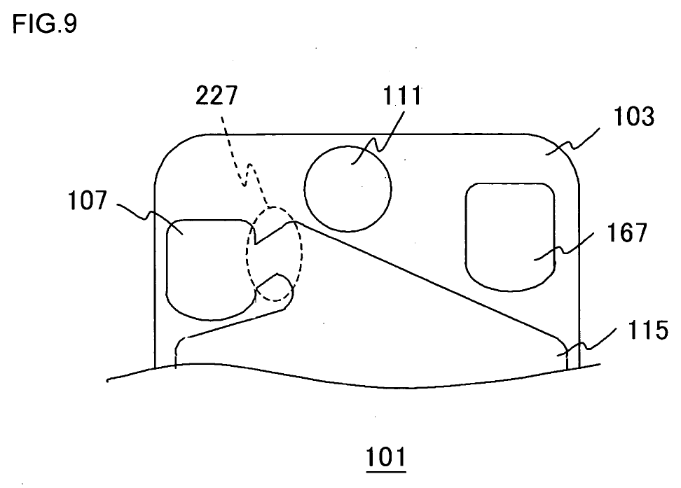

FIG. 9 shows an alternative structure of the fuel electrode separator 101. The basis structure of the fuel electrode separator 101 is the same as that of FIG. 1A, a difference being that a connecting passage 227 is formed. The connecting passage 227 slants upward from the first manifold for fuel supply 107 and communicates with the second manifold for fuel supply 115.

In the structure of FIG. 9, the connecting passage 227 guides the fuel gas past the first manifold for fuel supply 107 toward the top of the fuel electrode separator 101. Accordingly, the fuel gas is guided toward the top of the fuel electrode separator 101 and then flows to the second manifold for fuel supply 115 downward. The coolant flows at the back of the connecting passage 227.

Consequently, it is ensured that the condensed water generated from condensation of fuel gas is collected at the bottom of the first manifold for fuel supply 107. The fuel gas with a high dew-point temperature moves upward in the connecting passage 227. Thus, in the structure of FIG. 9, a mechanism for removing the condensed water and guiding the fuel gas to the fuel passages 105 is implemented in a simple structure. Accordingly, blockage of the fuel passages 105 occurring when the fuel gas moving in the connecting passage 227 includes condensed water is successfully prevented.

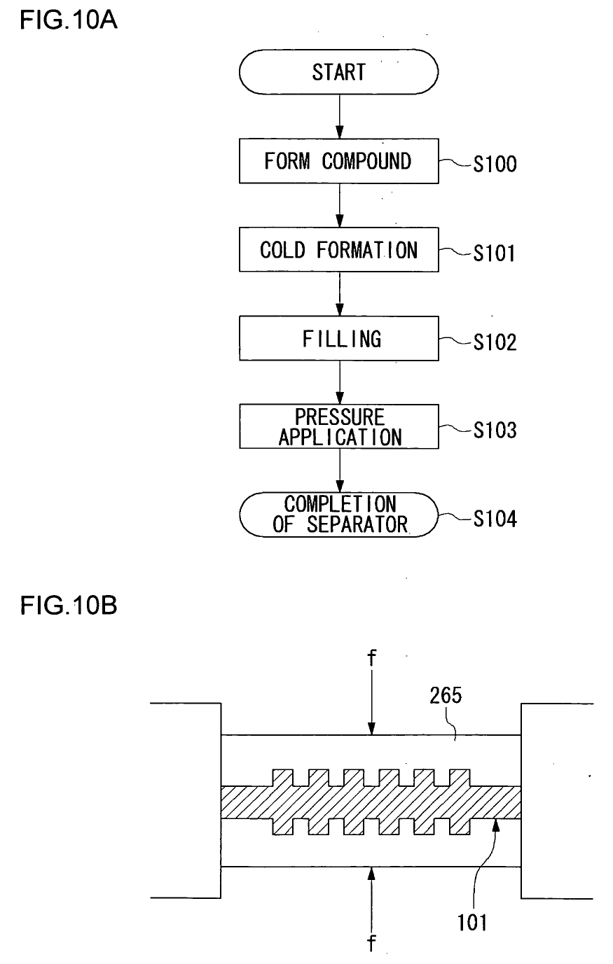

A description will now be given of a method of fabricating the fuel electrode separator 101 and the air electrode separator 147. The method for fabricating the separator 101 is described as a representative example. The air electrode separator 147 is fabricated in a similar manner. FIGS. 10A and 10B illustrate a method of fabricating fuel cell separators according to the first embodiment.

The fuel electrode separator 101 and the air electrode separator 147 can be formed of a mixture of carbon particles and thermosetting resin particles. Since the resin particles serve as a binding agent, formation is easy. Accordingly, inexpensive plates are obtained. The carbon particles and the thermosetting resin particles may be mixed at a weight ratio between 1:1 and 19:1.

FIG. 10A is a flowchart showing a process of fabricating the fuel electrode separator 101. FIG. 10B illustrates the fabrication. As shown in FIG. 10A, graphite particles and thermosetting resin particles are mixed uniformly so that a compound subject to a proper control is formed (S100). A contact pressure in the range between 2 MPa and 10 MPa is applied to the compound so that a preliminary configuration which is an approximation of a final configuration is cold formed (S101). Subsequently, the preliminarily formed piece is made to fill a metal mold 265 having a final configuration, as shown in FIG. 10B (S102). In this state, the metal mold 265 is heated at a temperature in the range between 150° C. and 170° C. Concurrently with this, a press (not shown) is operated. At this point of time, a contact pressure in the range between 10 MPa and 100 MPa, and preferably in the range between 20 MPa and 50 MPa is applied as indicated by the arrow f (S103). In this way, the fuel electrode separator 101 having the final configuration commensurate with the configuration of the metal mold 265 is fabricated (S104).

By fabricating the fuel electrode separator 101 such that a compound having a configuration which is an approximation of the final configuration is preliminarily formed, the preliminarily formed piece made is to fill the metal mold 265, a contact pressure as high as 10-100 MPa (preferably, 20-50 MPa) is applied to the piece while the piece is being heated at a temperature of 150-170° C., the thermosetting resin is dissolved and a thermosetting reaction occurs. As a result, the fuel electrode separator 101 of a predetermined configuration having a high molded piece density is uniformly formed.

### Second Embodiment

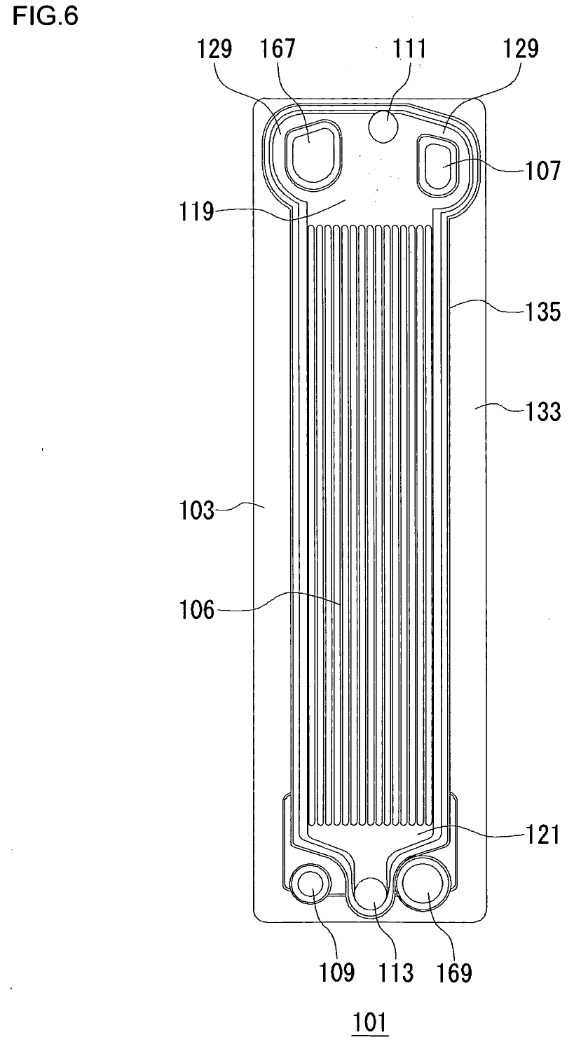

FIG. 6 shows a structure of a surface of a fuel cell separator according to the second embodiment on which surface coolant passages formed. Fuel passages are formed on the opposite surface not shown. The basic structure of the separator of FIG. 6 is the same as that of FIG. 1B. A difference is that the coolant introduction passage 129 is formed to surround the entirety of the first manifold for fuel supply 107 and the first manifold for air supply 167.

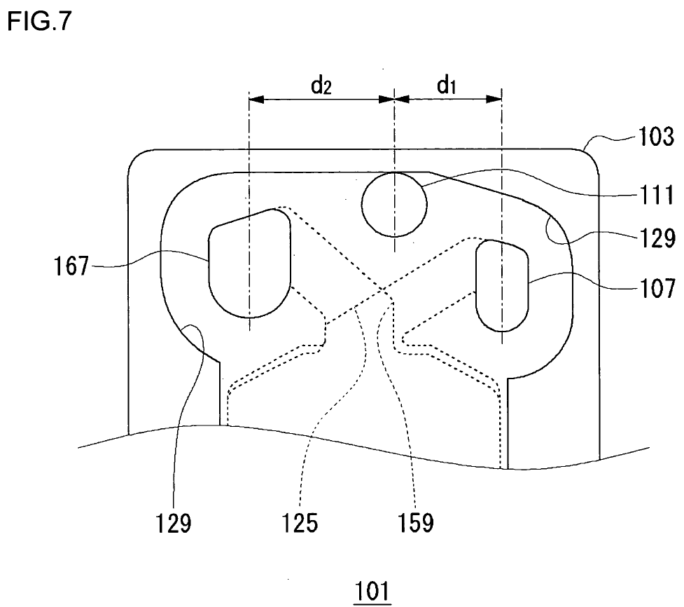

FIG. 7 shows that, in a similar configuration as the first embodiment, the first manifold for coolant supply 111 is located between the first manifold for fuel supply 107 and the first manifold for air supply 167. The distance d1 between the first manifold for coolant supply 111 and the first manifold for fuel supply 107 is smaller than the distance d2 between the first manifold for coolant supply 111 and the first manifold for air supply 167.

The same advantages as available in the first embodiment are also available in the fuel cell according to the second embodiment. In the structure according to the second embodiment, the coolant introduction passage 129 is formed to surround the entirety of the first manifold for air supply 167 and the first manifold for fuel supply 107 so that the cooling of fuel gas and air is more successfully prevented. Consequently, the output of the fuel cell is more stabilized.

Described above is an explanation of the present invention based on the embodiment. The description of the embodiments is for illustrative purposes only and it will be obvious to those skilled in the art that various variations in constituting elements are possible within the scope of the present invention.

In the above-described embodiments, one set of coolant passages 106 is provided in the cell 50. Alternatively, for example, when there is a need to reduce the thickness of fuel cell, a stack may be formed differently such that one set of coolant passages 106 is provided for two cells 50 as long as the required cooling efficiency is secured.

Further, the fuel cell according to the embodiments of the present invention may include a separator provided only with a surface on which the coolant passages 106 are formed.

In the fuel electrode separator 101 or the air electrode separator 147, the sealing member 133 or the sealing member 151 around the respective passages may be provided on a different surface. That is, the sealing member may be provided on a surface on which the fuel passages 105 are formed or on a smooth surface on which passages are not formed.

In the embodiments, the coolant passages 106 are formed on the back of the fuel passages 105. Alternatively, the coolant passages 106 may be formed on the back of the air passages 153.

The first manifold for coolant supply 111 and the first manifold for coolant emission 113 may be interchanged so that the first manifold for coolant emission 113 may be used for supply of coolant and the first manifold for coolant supply 111 may be used for emission of coolant.

1. A fuel cell comprising:
a membrane and electrode assembly having an electrolyte and a pair of electrodes provided on respective sides of the electrolyte; and
a pair of separators sandwiching said membrane and electrolyte assembly, wherein
each of said pair of separators is provided with an opening for supply of a reactant gas, one of surfaces of each separator is provided with reactant gas passages and a reactant gas introduction passage for guiding the reactant gas from the opening for supply of a reactant gas to the reactant gas passages, and a coolant passage is provided on the back of the reactant gas introduction passage of at least one of said pair of separators.

2. The fuel cell according to claim 1, wherein
the coolant passage is formed so that the coolant flows around the entirety of the opening for supply of the reactant gas.

3. The fuel cell according to claim 1, wherein
an opening for supply of the coolant is provided in said pair separators,
the opening for supply of the reactant gas and the opening for supply of the coolant are provided above the reactant gas passages,
the opening for supply of the coolant is located substantially above the opening for supply of the reactant gas, and
the coolant flows vertically downward from the opening for supply of the coolant.

4. The fuel cell according to claim 2, wherein
an opening for supply of the coolant is provided in said pair separators,
the opening for supply of the reactant gas and the opening for supply of the coolant are provided above the reactant gas passages,
the opening for supply of the coolant is located substantially above the opening for supply of the reactant gas, and
the coolant flows vertically downward from the opening for supply of the coolant.

5. The fuel cell according to claim 3, wherein
the opening for supply of the coolant is located between two openings for supply of the reactant gas respectively supplying a fuel gas and an oxidizing gas, and
the opening for supply of the coolant is closer to the opening supplying the fuel gas than to the opening supplying the oxidizing gas.

6. The fuel cell according to claim 4, wherein
the opening for supply of the coolant is located between two openings for supply of the reactant gas respectively supplying a fuel gas and an oxidizing gas, and
the opening for supply of the coolant is closer to the opening supplying the fuel gas than to the opening supplying the oxidizing gas.

7. The fuel cell according to claim 1, wherein the reactant gas introduction passage includes a connecting passage that runs upward from the opening for supply of the reactant gas.

8. The fuel cell according to claim 2, wherein the reactant gas introduction passage includes a connecting passage that runs upward from the opening for supply of the reactant gas.

9. The fuel cell according to claim 3, wherein the reactant gas introduction passage includes a connecting passage that runs upward from the opening for supply of the reactant gas.

10. The fuel cell according to claim 4, wherein the reactant gas introduction passage includes a connecting passage that runs upward from the opening for supply of the reactant gas.

11. The fuel cell according to claim 5, wherein the reactant gas introduction passage includes a connecting passage that runs upward from the opening for supply of the reactant gas.

12. The fuel cell according to claim 6, wherein the reactant gas introduction passage includes a connecting passage that runs upward from the opening for supply of the reactant gas.

13. A fuel cell separator comprising:
an opening for supply of a reactant gas;
reactant gas passages provided on one of separator surfaces; and
a reactant gas introduction passage for guiding the reactant gas from the opening to the reactant gas passages, wherein
a coolant passage is provided on the back of the reactant gas introduction passage.

14. The fuel cell separator according to claim 13, wherein the coolant passage is formed so that the coolant flows around the entirety of the opening for supply of the reactant gas.

15. A fuel cell separator constructed such that a first base plate and a second base plate are in contact with each other, wherein
the first base plate comprises:
an opening for supply of a reactant gas;
reactant gas passages provided on a surface of the first base plate which is not in contact with the second base plate; and
a reactant gas introduction passage for guiding the reactant gas from the opening for supply of the reactant gas to the reactant gas passages, and wherein
the second base plate is provided with a cooling water passage on a surface of the second base plate which is in contact with the first base plate.
